(19) United States
(12) Patent Application Publication
(10) Pub. No.: US 2026/0169406 A1
(43) Pub. Date: Jun. 18, 2026

(54) FIXING DEVICE AND IMAGE FORMING APPARATUS

(71) Applicant: CANON KABUSHIKI KAISHA, Tokyo (JP)

(72) Inventors: TAKESHI KOZUMA, Ibaraki (JP); TAKUYA HASEGAWA, Tokyo (JP); KENICHI TANAKA, Ibaraki (JP); RIKIYA TAKEMASA, Chiba (JP); TATSUO YASUI, Tokyo (JP); TOMOYUKI KURIYAMA, Tokyo (JP); MASAKI FURUTANI, Chiba (JP)

(21) Appl. No.: 19/366,957

(22) Filed: Oct. 23, 2025

(30) Foreign Application Priority Data
Dec. 12, 2024 (JP) 2024-217461

(51) Int. Cl. G03G 15/20

(52) U.S. Cl. CPC G03G 15/2032; G03G 15/2064; G03G 2215/2041

(57) ABSTRACT

Disclosed is a fixing device including: an endless belt; a pressurizing member that abuts against an outer circumferential surface of the endless belt; a nip forming member that forms a nip portion between the endless belt; a tensioning member that presses the endless belt to endow the endless belt with tension; a first holding member being configured to hold the tensioning member in the releasing position that is distanced from the pressing position in a direction opposite the pressing direction for a first distance; and a second holding member configured to hold the tensioning member in the middle position distanced from the pressing position in a direction opposite the pressing direction for a second distance shorter than the first distance.

### BACKGROUND

### Field of the Technology

This disclosure relates to a fixing device that fixes a toner image formed on a recording material, and to an image forming apparatus with the fixing device.

### Description of the Related Art

Conventionally, an image forming apparatus of the electrophotographic system has a fixing device that fixes an unfixed toner image formed on a recording material to a recording material. The configuration of the fixing device is known as the one in which a toner image is fixed between a fixing belt as an endless belt suspended by multiple suspending members and a pressurizing member that abuts against the outer circumferential surface of the fixing belt (Japanese Patent Application Laid-open No. 2021-33204).

The Japanese Patent Application Laid-open No. 2021-33204 discloses a fixing device in which a nip portion is formed between a fixing belt and a pressurizing roller using a pad member that nips the fixing belt between the pressurizing roller and the pad member. By using the pad member, a wide nip portion can be formed without enlargement of the apparatus, so that a toner image can be fixed on a recording material in a shorter time period and at a lower temperature.

Further, the position of the fixing belt in the width direction is controlled by detecting the position of the fixing belt with a photosensor and a flag and by inclining a steering roller as one of suspending members based on a detection result. A tension is applied to the fixing belt by pressing the steering roller to the fixing belt for the position control by the steering roller.

### SUMMARY

One aspect of the present disclosure is a fixing device comprising:
an endless belt rotatably suspended by a plurality of suspending members;
a pressurizing member that abuts against an outer circumferential surface of the endless belt;
a nip forming member that is brought in contact with an inner circumferential surface of the endless belt and that forms a nip portion between the endless belt and the pressuring member in a position opposed to the pressurizing member;
a tensioning member that rotatably suspends the endless belt and that presses the endless belt to endow the endless belt with tension;
a first holding member supported such that the first holding member can be moved between a pressing position where the endless belt is pressed by the tensioning member and a releasing position where the pressing by the tensioning member on the endless belt is released, the first holding member being configured to hold the tensioning member in the releasing position that is distanced from the pressing position in a direction opposite the pressing direction for a first distance; and
a second holding member configured to hold the tensioning member in the middle position distanced from the pressing position in a direction opposite the pressing direction for a second distance shorter than the first distance.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a main cross-sectional view of an image forming apparatus.

FIG. 2 is a schematic diagram showing a cross-sectional view of a fixing device in the image forming apparatus.

FIG. 3 is a diagram showing a perspective view of the fixing device.

FIG. 4 is a diagram showing a perspective view of the fixing device.

FIG. 5 is a diagram showing a perspective view of the fixing device according to the first embodiment.

FIG. 6 is a diagram showing a perspective view of the fixing device according to the first embodiment.

FIG. 7 is a diagram showing a cross-sectional view of the fixing device according to the first embodiment.

FIG. 8 is a diagram showing a cross-sectional view of the fixing device according to the first embodiment.

FIG. 9 is a diagram showing a cross-sectional view of the fixing device according to the first embodiment.

FIG. 10 is a diagram showing a perspective view of the fixing device according to the second embodiment.

FIG. 11 is a diagram showing a cross-sectional view of the fixing device according to the second embodiment.

### DESCRIPTION OF THE EMBODIMENTS

Hereinafter, with reference to the drawings, embodiments of the present disclosure will be described. The sizes, materials, shapes and relative arrangement of the components described in the following are just examples and the scope of the disclosure is not intended to limit to only ones in the following embodiments.

### First Embodiment

The image forming apparatus with a fixing device according to the first embodiment will be described. In the following, the description will be made by exemplifying a full-color copying machine equipped with a plurality of photosensitive drums as an image forming apparatus. However, this disclosure is not limited to his configuration, but can be applied to other image forming apparatuses such as a monochrome copying machine, a monochrome printer, that have a single photosensitive drum, and a full-color laser beam printer. Further, this disclosure is also applied to a fixing device used in these image forming apparatuses.

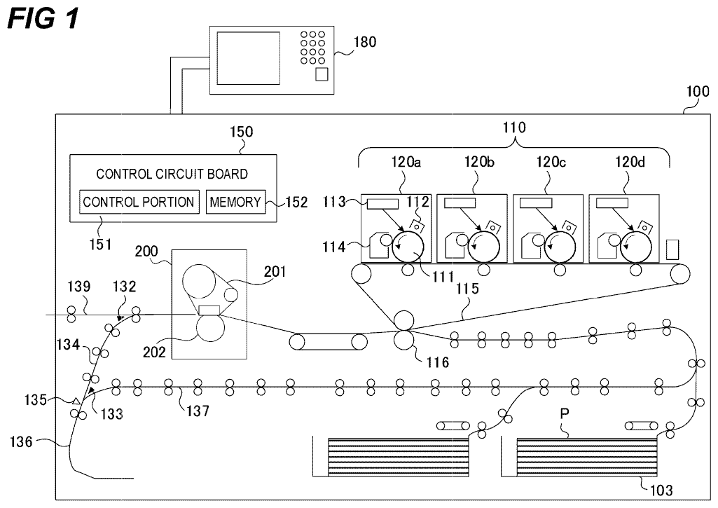

First, the image forming apparatus will be described referring to FIG. 1. FIG. 1 is a diagram showing a principal cross-section of the overall configuration of the image forming apparatus 100.

### Image Forming Apparatus

The image forming apparatus 100 is provided with the image forming portion 110 that forms an image on the recording material P, the fixing device 200 that fixes an image formed on the recording material P, the operation portion 180, and the control circuit board 150.

The image forming apparatus 100 conveys the recording material P conveyed from the recording material accommodating portion 103 to the image forming portion 110 where a toner image is formed on the recording material P. Thereafter, the image forming apparatus 100 conveys the recording material P on which a toner image has been formed in the image forming portion 110 to the fixing device 200 where an unfixed toner on the recording material P is fixed to the recording material P by applying heat and pressure. The recording material P is for example a sheet of paper or a sheet for OHP.

The image forming apparatus 100 includes the stations (image forming portions) 120a, 120b, 120c and 120d as the image forming portion 110. Further, the image forming apparatus 100 is provided with the intermediate transfer belt 115 and the transfer roller 116. The stations 120a, 120b, 120c and 120d respectively form toner images of yellow, magenta, cyan and black and transfer the toner images on the intermediate transfer belt 115.

Each of the stations 120a to 120d includes the photosensitive drum 111 as an image bearing member, the primary charging device 112 as a process device that affects the photosensitive drum 111, the developing device 114, and so on. The stations 120a to 120d are configured similarly with each other except for toner color.

In the station 120a, the photosensitive drum 111 as an image bearing member rotates in the counterclockwise direction in FIG. 1. The primary charging device 112 charges the surface of the photosensitive drum 111 to a uniform potential. The laser unit 113 includes a light source for emitting a laser beam and forms a latent image on the photosensitive drum 111. The developing device 114 forms a toner image by developing the latent image formed on the photosensitive drum 111 using developer including toner. The configurations of the stations 120b, 120c and 120d are the same as that of the station 120a and the duplicate description will be omitted.

The toner images formed by the stations 120a, 120b, 120c and 120d are transferred onto the intermediate transfer belt 115 by being superimposed with each other. The transfer roller 116 transfers the toner images on the intermediate transfer belt 115 to the recording material P conveyed from the recording material accommodating portion 103.

The fixing device 200 fixes the toner image transferred onto the recording material P to the recording material P by applying heat and pressure to the recording material P. The fixing device 200 is provided with the fixing belt 201, the pressurizing roller 202 and so on.

In case of single-sided printing, the image forming apparatus 100 guides the recording material P on which an image has been formed by the image forming portion 110 and the fixing device 200 to the discharge path 139 using the flapper 132, and discharges the recording material P outside the apparatus using discharge roller. The flapper 132 is a guiding member that guides the recording material P on which an image has been formed by the image forming portion 110 and the fixing device 200 to the conveying path 134 or outside the image forming apparatus 100.

On the other hand, in duplex printing, the image forming apparatus 100 reverses the recording material P on one side of which an image has been formed and conveys it to the image forming portion 110 again. Specifically, the recording material P after fixation is guided to the conveying path 134 by the flapper 132, and is conveyed to the reverse portion 136. When the reverse sensor 135 detects the back end of the recording material P, the flapper 133 switches the direction of conveying the recording material P to the conveying path 137. The image forming apparatus 100 conveys the recording material P reversed by the reverse portion 136 to the flapper 133, to the image forming apparatus 100 again via the conveying path 137, and further to fixing device 200. The recording material P on both surfaces of which an image has been formed is guided to the discharge path 139 by the flapper 132 and is discharged outside the apparatus.

The operation portion 180 is provided with a display screen and selection keys. On the display screen of the operation portion 180, the state of the image forming apparatus 100 is displayed and a user can input an instruction of the operation with the selection keys.

In this embodiment, the operation portion 180 is exemplified by a configuration provided with a display screen and selection keys. However, the configuration is not limited to this one. The display screen of the operation portion 180 can be a touch panel type liquid crystal display screen. In this case, numeric keys for inputting a number of copying sheets and a destination telephone number for facsimile transmission are displayed in a predetermined area on the display screen as software keys. In case of a touch panel type (liquid crystal) display screen, touch operations of a user such as flick, swipe and scroll are possible for inputting information.

The control circuit board 150 includes the control portion 151 and the memory 152 and controls unit portions of the image forming apparatus 100. The control portion 151 outputs signals to electric components for the electric components to operate at a desired timing and necessary control amount based on the detection signals input from the sensors and information stored in the memory 152. Therefore, it is this control portion 151 that actually controls the electric components. The memory 152 stores information data necessary to control the unit portions. The control portion 151 writes and reads the information data stored in the memory 152.

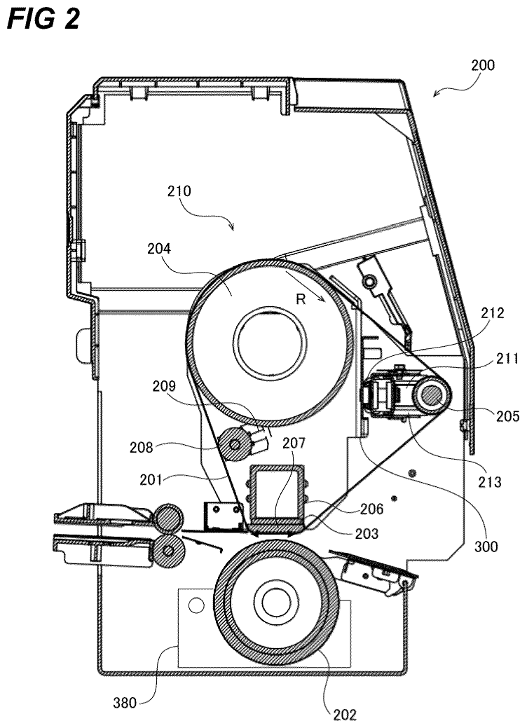

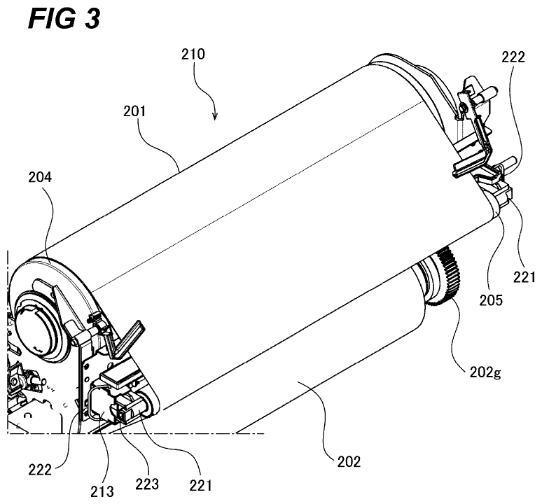

Next, the configuration of the fixing device according to the present embodiment will be described with reference to FIGS. 2 and 3.

FIG. 2 is a diagram showing a cross-sectional view of the fixing device in the present embodiment and FIG. 3 is a diagram showing a partial perspective view of the fixing device 200.

### Fixing Device

FIG. 2 is a schematic diagram showing the overall configuration of the fixing device 200 of the belt heating system according to the present embodiment. In the fixing device 200 shown in FIG. 2, the recording material P is conveyed in the leftward direction in FIG. 2. The fixing device 200 has the heating unit 210 and the pressurizing roller 202 as a pressurizing member that abuts against the heating unit 210. The heating unit 210 and the pressurizing roller 202 are supported by the housing frame 300 of the fixing device 200. The heating unit 210 has the fixing belt (hereinafter referred to as belt) 201 as a rotatable endless belt, the pressurizing pad (hereinafter referred to as pad) 203 as a nip forming member, the heating roller 204 as a suspending member, and the steer roller 205 as a suspending member. The pressuring roller 202 is opposed to the belt 201 and is in contact with the outer circumferential surface of the belt 201 to form the nip portion N together with the belt 201.

Since the belt 201 is heated by the heating roller 204 having a heat source, the belt 201 has heat conductivity and heat resistance. The belt 201 has a thin cylindrical shape. In the present embodiment, the belt 201 has three-layered structure including a basic layer, an elastic layer provided at the outer circumference of the basic layer, and a release layer at the outer circumference of the elastic layer. The base layer is 60 μm thick and made of polyimide resin (PI). The elastic layer is 300 μm thick and made of silicone rubber. The release layer is 30 μm thick and made of PFA (Tetrafluoroethylene-perfluoroalkoxyethylene copolymer resin) as a fluoropolymer. The belt 201 is suspended by multiple suspending members to be rotatable. Specifically, the belt 201 is tensioned to be rotatable by the pad 203, the heating roller 204, and the steer roller 205.

The pad 203 is in contact with the inner circumferential surface of the belt 201 in the position opposed to the pressurizing roller 202. The pad 203 is a nip forming member that presses the pressurizing roller 202 via the belt 201 and forms the nip portion N with a predetermined width in the recording material conveying direction between the belt 201 and the pressurizing roller 202. The pad 203 is a long member along a width direction perpendicular to the rotating direction of the belt 201 and a cross-section of the pad 203 is substantially of a rectangular shape. The pad 203 needs heat resistance property and LCP (Liquid Crystal Polymer) is used for the material for the pad 203.

Between the pad 203 and the belt 201, the sliding sheet 207 whose surface is coated by PTFE and silicone oil (hereinafter referred to as oil) as lubricant are intervened, so that the belt 201 smoothly slides on the pad 203. The sliding sheet 207 is formed by a polyimide base material with the thickness of 70 [μm] whose surface is coated by PTFE. The sliding sheet 207 is disposed for improving the sliding property between the pad 203 and the belt 201. Instead of the sliding sheet 207, the coating for improving the sliding property can be made on the surface layer of the pad 203.

The pressurizing roller 202 is a roller (pressurizing rotating member) that has a shaft, an elastic layer on the outer circumference of the shaft, and a releasing layer on the outer circumference of the elastic layer. The shaft is made of stainless steel. The elastic layer is made of electrically conductive silicone rubber and has thickness of 5 [mm]. The releasing layer is made of PFA as fluoro plastic and has thickness of 50 [μm]. The pressurizing roller 202 is axially supported by the pressurizing arm 380 movably provided on the fixing device 200. The gear 202g (see FIG. 3) is secured on one end portion in the axial direction. Via the gear, the pressurizing roller 202 is connected to a driving source (not shown) to drive the pressurizing roller 202 to rotate. The belt 201 rotates in the direction indicated by the arrow R while being nipped by the rotating pressurizing roller 202 and the pad 203. The both ends of the pressurizing roller 202 in the axial direction are held by bearings. The pressurizing roller 202 is supported at the pressurizing arm 380 by an attaching and detaching unit (not shown) such that the pressurizing roller 202 is movable between a sheet passing position (the position shown in FIG. 1) where the pressurizing roller 202 pressurizes the pad 203 via the belt 201 and a separated position (the position shown in FIG. 2) where the pressurizing roller 202 is separated from the belt 201. The pressurizing roller 202 applies a pressurizing force of about 1000 N.

When keeping the pressurizing roller 202 at the sheet passing position with the pressurizing roller 202 being stopped, a permanent deformation is produced on a part of the rubber portion (elastic layer) in the circumferential direction, which may cause unevenness of the rotation and the surface properties. Therefore, when the image forming apparatus is not used, for example, when the image forming apparatus is transported from a production site to a user's place, the pressurizing roller 202 is required to be kept in the state where the pressurizing roller 202 moved to the above-described separated position (the state shown in FIG. 2). In the present embodiment, the pressurizing roller 202 is moved to the above-described separated position when a cover (not shown) is opened to remove the fixing device 200 from the image forming apparatus 100 and when the power of the image forming apparatus 100 is turned off.

The oil supplying roller 208 is a suspending member that rotatably suspends the belt 201 and a supplying member that abuts against the inner circumferential surface of the belt 201 to supply lubricant. The oil supplying roller 208 is formed by winding unwoven fabric with a thickness of 100 [μm] around a roll-like member and by impregnating it with silicone oil. The oil supplying roller 208 abuts against the inner circumferential surface of the belt 201 at a predetermined abutting pressure (3.0 N in this embodiment) by the pressing spring 209 while being supported by a frame of the heating unit 210 such that the oil supplying roller 208 is driven to rotate.

The oil applied between the pad 203 and the belt 201 as lubricant deteriorates, and decreases due to leakage to the outside as the fixing device 200 operates. When the oil between the pad 203 and the belt 201 decreases, a sliding resistance between the pad 203 and the belt 201 increases, which may cause a problem such as a defect in driven rotation of the belt 201. By the oil supplying roller 208 abutting against the belt 201, oil can be supplied to the inner circumferential surface of the belt 201. As a result, the oil intervening between the pad 203 (sliding sheet 207) and the belt 201 can be maintained for a long time to ensure a stable operation of the fixing device 200.

In FIG. 2, the stay 206 is a reinforcing member with rigidity that is long in the width direction of the belt 201 and is disposed inside the pad 203 (at the opposite side of the sliding sheet 207) to back up the pad 203. The stay 206 is made by molding a drawn member of SUS 304 with thickness of 3 [mm] to a hollowed squared shape in a cross-section to ensure strength. When the pad 203 is pressed by the pressurizing roller 202, the stay 206 endows the pad 203 with strength to ensure the pressing force of the nip portion N. Stainless steel is used for the material of the stay 206, however, the material is not limited to stainless steel as long as the enough strength is obtained.

The heating roller 204 is a suspending member that rotatably suspends the belt 201 and a heating rotating member that is in contact with the inner circumferential surface of the belt 201 to heat the belt 201. The heating roller 204 in FIG. 2 is a pipe made of stainless steel with a thickness of 1 [mm] formed to have an outer diameter of 80 [mm]. A halogen heater (not shown) as a heating source is disposed inside the heating roller 204 to generate heat to a predetermined temperature. The belt 201 is controlled to be heated by the heating roller 204 to a predetermined target temperature in response to sheet types based on a temperature detected by a thermistor.

The steer roller 205 in FIG. 2 suspends the belt 201 and is supported by the steer frame 213 via the steer bearing portion 221. In this embodiment, the steer roller 205 is configured to by formed by silicone rubber with a thickness of 200 [μm] on the surface layer of a hollowed roll portion made from stainless steel with an outer diameter of 20 [mm]. The steer roller 205 is rotatably supported by the steer roller shaft 223 via a bearing.

The steer roller shaft 223 is supported by the pair of the steer bearing portions 221 at both ends. The steer bearing portions 221 are formed from resin such as PPS that can be used under a high temperature environment and is attached such that the steer bearing portions 221 can be moved along a side wall of the box-like steer frame 213. The steer frame 213 is a supporting member that supports the steer bearing portions 221 such that the steer bearing portions 221 can move between the pressing position where the steer roller 205 presses the belt 201 and the releasing position where the pressing of the steer roller 205 to the belt 201 is released. By the steer bearing portions 221 being pressed by the spring 211 supported by the steer frame 213, the steer roller 205 is pressed (urged) to the belt 201. As a result, the belt 201 is suspended with tension by the steer roller 205, the heating roller 204 and the pad 203. In this suspended state, the steer roller 205 abuts against the belt 201 with a predetermined pressing force (20 N in this embodiment) by the spring 211.

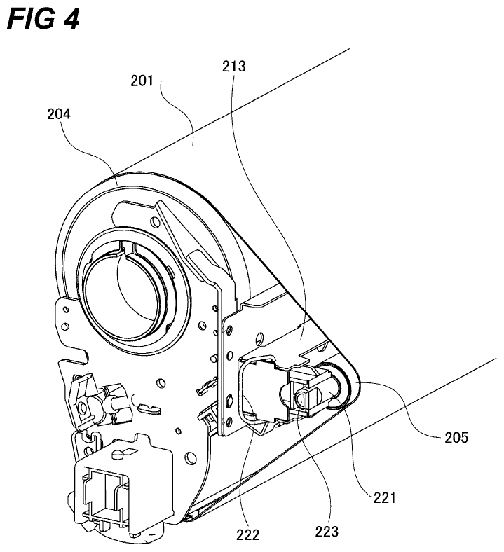

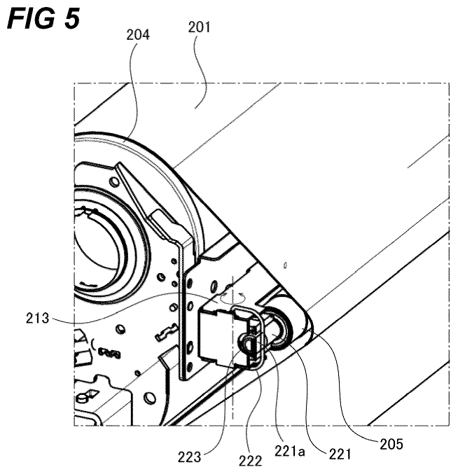

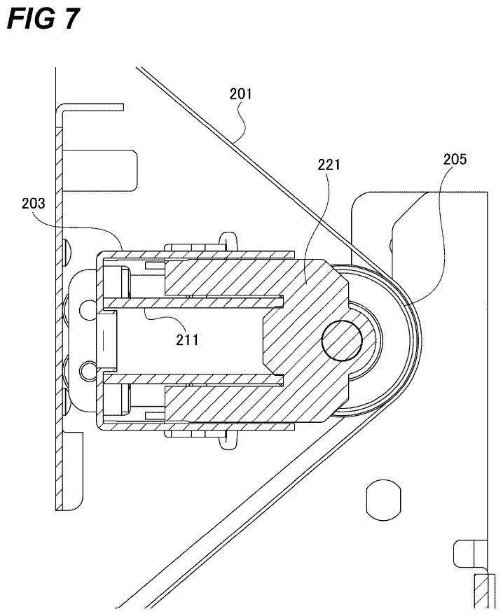

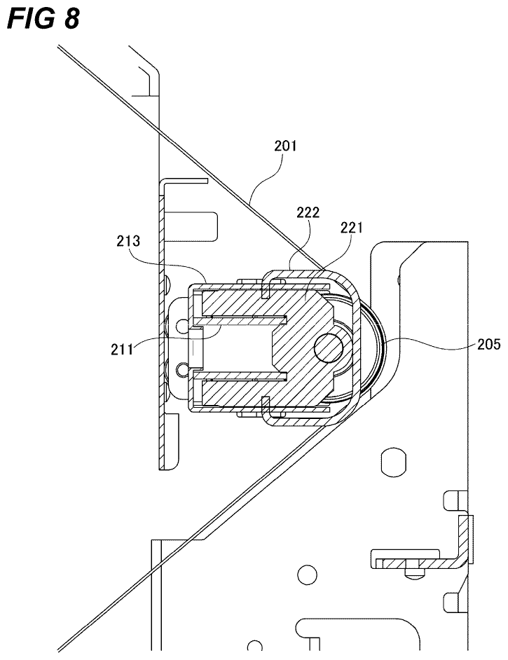

As described above, the steer roller 205 is a suspending member that rotatably suspends the belt 201 and a tensioning member that endows the belt 201 with tension by pressing the belt 201. The steer roller 205 is supported by the steer frame 213 such that the steer roller 205 can be moved between the pressing position shown in FIGS. 4 and 7 where the belt 201 is pressed and the releasing position shown in FIGS. 5 and 8 where the pressing of the steer roller 205 to the belt 201 is released.

The steer roller 205 is provided such that the steer roller 205 can be tilted with respect to the frame of the heating unit 210 around the rotation shaft 212 as a rotation fulcrum in the width direction of the belt 201. Specifically, the steer roller 205 is provided such that the steer frame 213 that supports the steer roller 205 movably in the pressing direction can be tilted with respect to the frame of the heating unit 210 around the rotation shaft 212 in the width direction of the belt 201. The the rotation shaft 212 is a shaft whose center axis is along the direction perpendicular to the rotation direction and width direction of the belt 201 and is provided at the center in the width direction. The configuration is exemplified in which the rotation shaft 212 is provided at the center in width direction. However, the configuration is not limited to this one and the rotation shaft 212 can be provided, for example, at one end portion in width direction. When the steer roller 205 is tilted in the width direction of the belt 201 around the rotation fulcrum, the relative angle of the steer roller 205 with respect to the other suspending members that suspend the belt 201 changes. As a result, a tension difference occurs back and forth between one side and the other side in width direction perpendicular to the rotation direction of the belt 201, so that the position in the width direction of the belt 201 (main scanning direction) is controlled.

Namely, the steer roller 205 is a steering member that adjusts the position in the width direction perpendicular to the rotation direction of the belt 201 and also is a tension roller (tensioning member) that endows the belt 201 with tension.

Next, referring to FIGS. 4 to 9, the moving configuration of the steer roller 205 that is one of the belt suspending members in the present embodiment will be described. When an operation is performed to the housing portion in which the fixing device 200 is removed from the image forming apparatus 100 and the cover is removed, the pressurizing roller 202 is moved to the separated position shown in FIG. 2 where the pressurizing roller 202 is separated from the belt 201.

### Holding Member

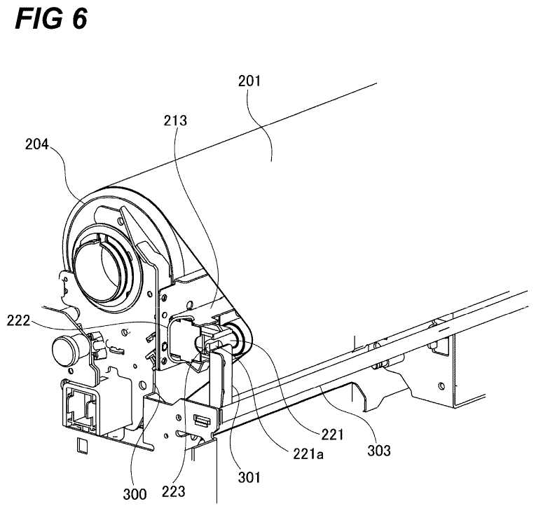

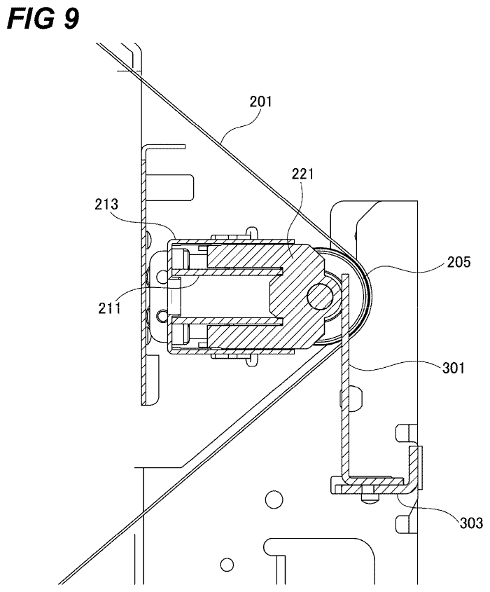

The fixing device 200 is provided with the steer lock arm 222 and the restricting member 301. The steer lock arm 222 is a first holding member that holds the steer roller 205 in the releasing position shown in FIGS. 5 and 8, which is distanced in the direction opposite from the pressing direction from the pressing position shown in FIGS. 4 and 7 for a first distance. The restricting member 301 is a second holding member that holds the steer roller 205 in the middle position shown in FIGS. 6 and 9, which is distanced in the direction opposite from the pressing direction from the pressing position for a second distance that is shorter than the first distance.

Therefore, the first pressing force F1 with which the belt 201 is pressed when the steer roller 205 is held in the releasing position by the steer lock arm 222 is less than the second pressing force F2 with which the belt 201 is pressed when the steer roller 205 is held in the middle position by the restricting member 301 (F1<F2).

The pressing force F with which the belt is pressed when the steer roller 205 is held neither by steer lock arm 222 nor by the restricting member 301 is greater than the first pressing force F1 and the second pressing force F2. Therefore, the second pressing force F2 with which the belt 201 is pressed by the steer roller 205 in the middle position is less than the pressing force F with which the belt 201 is pressed by the steer roller 205 in the pressing position and greater than the first pressing force F1 with which the belt 201 is pressed by the steer roller 205 in the releasing position.

FIGS. 5 and 8 show respectively a perspective view and a cross-sectional view of the fixing device 200 for describing the state where the tension of the steer roller 205 is released by the steer lock arm 222. In the present embodiment, the state where the tension of the steer roller 205 is released by the steer lock arm 222 means the state where the the pressing force of the steer roller 205 to the belt 201 becomes the least pressing force F1.

At both ends of the steer frame 213 in the longitudinal direction, the steer lock arm 222 as a first holding member is held. The steer lock arm 222 is formed by a wire spring with a wire diameter of 1 [mm] and is attached to the steer frame 213 such that the steer lock arm 222 can be rotated in the direction indicated by the arrow in FIG. 5. On the steer bearing portion 221, the mounting surface 221a is formed for mounting the steer lock arm 222. The mounting surface 221a is formed at the side on the steer bearing portion 221 opposed to the belt 201. In the state where the steer roller 205 is pressed in the direction opposite to the pressing direction of the spring 211, the steer lock arm 222 is hooked on the mounting surface 221a as shown in FIG. 5. As a result, the steer lock arm 222 holds the steer roller 205 in the releasing position retracted from the pressing position where the belt 201 is suspended with a predetermined tension. As a result, the contact force (pressing force) of the steer roller 205 to the belt 201 can be reduced so that the tension applied to the belt 201 can be weakened.

In the present embodiment, by hooking the steer lock arm 222 on the mounting surface 221a, the steer roller 205 is held in the releasing position distanced from the pressing position in the separating direction (opposite the pressing direction) for a first distance (5 [mm] in this embodiment). As a result, the steer roller 205 can be separated from the belt 201, so that the pressing force of the steer roller 205 to the belt 201 becomes the least pressing force F1. With this configuration, the attachment and detachment of the belt 201 can become easier to improve the operability for changing the belt 201.

FIGS. 6 and 9 show respectively a perspective view and a cross-sectional view of the fixing device 200 for describing the state where the tension of the steer roller 205 is released by the restricting member 301. In the present embodiment, the state where the tension of the steer roller 205 is released by the restricting member 301 means the state where the the pressing force of the steer roller 205 to the belt 201 is the second pressing force F2 that is less than the pressing force F and greater than the first pressing force F1.

The restricting member 301 as a second holding member is provided on each of both sides of the steer roller 205 in the longitudinal direction in the outside region in the width direction perpendicular to the rotation direction of the belt 201. Specifically, the restricting member 301 is detachably attached to the lower stay 303. The lower stay 303 is a component of the housing frame 300 of the fixing device 200. The restricting member 301 abuts against the steer bearing portion 221 in the middle position to restrict the movement of the steer roller 205 in the pressing direction.

FIG. 9 is a diagram showing a cross-sectional view of the fixing device 200 for describing the state where the tension of the steer roller 205 is released by the restricting member 301. The restricting member 301 is a bent metal plate component with a plate thickness of about 2 [mm]. The restricting member 301 is removably secured to the lower stay 303 with a securing member such as a screw. When the restricting member 301 is attached, the restricting member 301 is pressed to the external form of the steer bearing portion 221 and the position is secured by tightening the screw to the lower stay 303 while the steer bearing portion 221 is being swung in the direction opposite the pressing direction. The secured restricting member 301 presses the steer bearing portion 221 in the direction opposite the pressing direction against the force of the spring 211 so that the tension applied to the belt 201 can be weakened.

In the present embodiment, in the state where the restricting member 301 is secured to the lower stay 303, the steer roller 205 is held in the middle position distanced in the separating direction from the pressing position for the second distance (1 [mm] in the present embodiment) shorter than the first distance. As a result, the second pressing force F2 with which the belt 201 is pressed by the steer roller 205 in the middle position is less than the first pressing force F with which the belt is pressed by the steer roller 205 in the pressing position and greater than the first pressing force F1 with which the belt is pressed by the steer roller 205 in the releasing position, enabling the tension applied to the belt 201 to be weakened by about 4 [N].

Further, oil is applied to the inner circumferential surface of the belt 201. The kinematic viscosity of the oil is set to 50 to 500 [CST] at high temperatures to present a desired sliding property at high temperatures when a fixing operation is performed. During the transportation of the image forming apparatus from the production site to a user's place, the heating unit 210 does not operate so that the viscosity of the oil becomes high. As a result, the heating roller 204 that suspends the belt 201 and the steer roller 205 becomes in a close contact with the belt 201 via oil. A contact area between the belt 201 and the heating roller 204 is larger than a contact area between the belt 201 and the steer roller 205. As a result, a constraint force of the heating roller 204 is also larger than that of steer roller 205.

In the separated state where the pressurizing roller 202 is separated from the belt 201, the contact force between the pad 203 and belt 201 becomes weak. Therefore, in the separated state, the position of the belt 201 in the width direction is held by the heating roller 204 and the steer roller 205. When the image forming apparatus get vibration during transportation, the heating roller 204 and the steer roller 205 vibrate and move in the width direction. In this case, the belt 201 vibrates while being held by the heating roller 204 having a large constraint force. However, the belt 201 is affected by the constraint force of the steer roller 205 so that the belt 201 positionally shifts relative to the heating roller 204.

By the steer roller 205 being maintained in the middle position by the restricting member 301, the pressing force of the steer roller 205 to the belt 201 can be decreased as compared in the case in the pressing position and can be increased as compared in the case in the releasing position. As a result, the positional shift of the belt 201 produced by the difference in the above described constraint forces can be suppressed. Further, when the steer roller 205 is completely separated from the belt 201, the steer roller 205 has to endure the vibration during the transportation with the retention force by only the heating roller 204, which may cause the effect for suppressing the positional shift to be reduced on the contrary. Therefore, the moving amount of the steer bearing portion 221 in the case of releasing of pressing by the steer lock arm 222 for improving the operability of changing the belt 201 is set to be less than that in the case of releasing of pressing by the restricting member 301.

By transporting the product with the tension applied to the belt 201 being weakened by the restricting member 301 and by removing the restricting member 301 from the lower stay 303 after loosening the screws when the product is installed, the tension applied to the belt 201 can be returned to the initial state during the operation of the product.

With the above configuration, when the belt 201 is changed, the steer roller 205 is moved in the separating direction using the steer lock arm 222 and when the product is transported, the steer roller 205 is moved in the separating direction using the restricting member 301. This enables the positional shift of the belt 201 due to the vibration during the transportation to be suppressed and the fixing device 200 whose belt 201 can be easily changed to be provided.

### Second Embodiment

An image forming apparatus provided with a fixing device according to the second embodiment will be described. The schematic configurations of the fixing device and the image forming apparatus are similar to those in the previous embodiment. Therefore, the same reference characters are added to members having equivalent functions and duplicate description will be omitted.

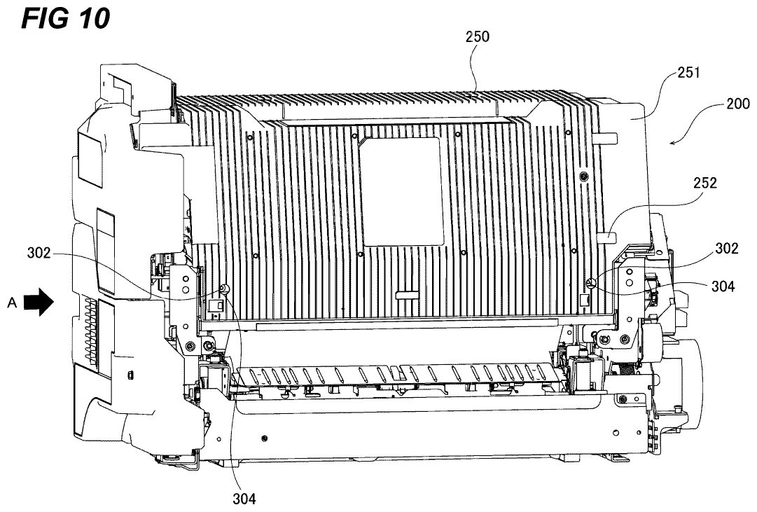

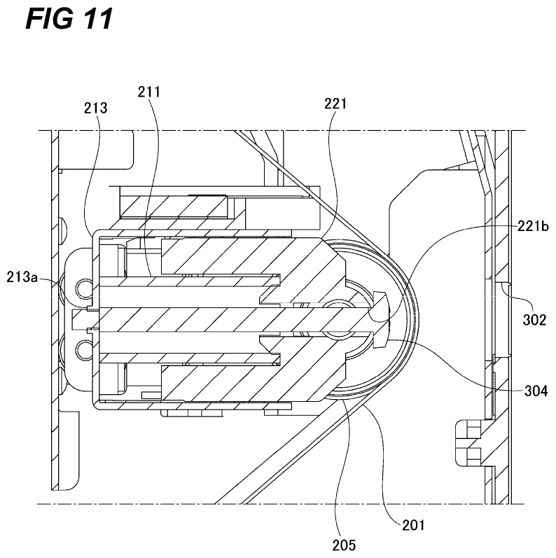

The configuration for moving the steer roller 205, which is one of the suspending members of the belt in the present embodiment will be described referring to FIGS. 10 and 11. When an operation is made to the housing portion, for example, the fixing device 200 is removed from the image forming apparatus 100 and an operation is made such as removing a cover, the pressurizing roller 202 is moved to the separated position separated from the belt 201 as shown in FIG. 2.

### Holding Member

The fixing device 200 is provided with the steer lock arm 222 and the releasing screw 304. The steer lock arm 222 is the first holding member and the same as the one in the previous embodiment. Therefore, the description thereof will be omitted. The releasing screw 304 is the second holding member that holds the steer roller 205 in the middle position distanced from the pressing position in the direction opposite the pressing direction for a second distance shorter than the first distance.

In the previous embodiment, the restricting member 301 is exemplified as the second holding member that is detachably attached to the housing frame 300 of the fixing device 200 and restricts the movement of the steer roller 205 in the pressing direction by abutting against the steer bearing portion 221 in the middle position. However, the second holding member is not limited to the restricting member 301.

In the present embodiment, the releasing screw 304 is provided as the second holding member. The releasing screw 304 is detachably attached to the steer frame 213. The releasing screw 304 moves the steer roller 205 in the direction opposite the pressing direction by being tightened to the steer frame 213 that movably support the steer roller 205.

The state where the tension of the steer roller 205 is released by the steer lock arm 222 is the same as that in the previous embodiment (see FIGS. 5 and 8) and the duplicate description will be omitted.

FIGS. 10 and 11 show respectively a perspective view and a cross-sectional view of the fixing device 200 for describing the state where the tension of the steer roller 205 is released by the releasing screws 304. In the present embodiment, the state where the tension of the steer roller 205 is released by the releasing screws 304 means the state where the pressing force of the steer roller 205 to the belt 201 is the second pressing force F2 that is less than the pressing force F and greater than the first pressing force F1.

The releasing screw 304 as the second holding member is provided on each of both sides of the steer roller 205 in the longitudinal direction in the outside region in the width direction perpendicular to the rotation direction of the belt 201. Specifically, the releasing screws 304 are respectively attached to the steer bearing portion 221 that supports both ends of the steer roller 205 (steer roller shaft 223). By being tightened into the steer frame 213, the releasing screws 304 moves the steer bearing portion 221 in the direction opposite the pressing direction to restrict the movement of the steer roller 205 in the pressing direction in the releasing position.

The fixing cover 250 of the fixing device 200 covers the belt 201 and the steer roller 205 that suspends the belt 201. As described above, when the belt 201 is changed after releasing the tension by the steer lock arm 222, the inside portion can be accessed after the fixing cover 250 is opened.

The fixing cover 250 is constituted by the cover portion 251 formed from resin and the plate portion 252 made from metal that holds the cover portion 251. The opening portions 302 are formed in the positions corresponding to the releasing screws 304 on the cover portion 251 and the plate portion 252, so that the releasing screws 304 are inserted through the opening portions 302 to be attached from outside the fixing device 200. Namely, when the tension of the steer roller 205 is released by the releasing screws 304, it is not necessary to open the fixing cover 250.

FIG. 11 is a diagram showing a cross-section of the fixing device 200 for describing the state where the tension of the steer roller 205 is released by the releasing screws 304. Specifically, FIG. 11 shows a cross-section including the center axis of the releasing screw 304 viewed from the direction of the arrow A in FIG. 10. The releasing screw 304 is a stepped screw having a body portion with a length of 30 [mm], a small diameter portion at the tip side via a stepped portion, and a large diameter portion at the screw head side via a stepped portion. When the releasing screw 304 is attached, the releasing screw 304 is inserted through the through hole 221b provided on the steer bearing portion 221, the small diameter portion of the releasing screw 304 is fastened to the tapped hole 213a provided on the steer frame 213. By the releasing screw 304 being fastened to the tapped hole 213a, the head portion of the releasing screw 304 presses the steer bearing portion 221 in the direction opposite the pressing direction against the force of the spring 211, so that the tension applied to the belt 201 can be weakened.

In the present embodiment, by the releasing screw 304 being tightened until the step portion of the releasing screw 304 abuts against the steer frame 213, the steer roller 205 is held in the middle position that is distanced from the pressing position in the separating direction for the second distance (1 [mm] in this embodiment) shorter than the first distance. As a result, the second pressing force F2 with which the steer roller 205 presses the belt 201 in the middle position becomes less than the pressing force F with which the steer roller 205 presses the belt in the pressing position and greater than the first pressing force F1 with with the steer roller 205 presses the belt in the releasing position, so that the tension applied to the belt 201 can be weakened by about 4 [N].

By the steer roller 205 being maintained in the middle position by the releasing screw 304, the pressing force of the steer roller 205 to the belt 201 can be decreased as compared with the case in the pressing position and can be increased as compared with the case in the releasing position. As a result, the positional shift of the belt 201 produced by the difference in the constraint forces with the heating roller 204 can be suppressed. Further, when the steer roller 205 is completely separated from the belt 201, the steer roller 205 has to endure the vibration during the transportation with the retention force by only the heating roller 204, which may cause the effect for suppressing the positional shift to be reduced on the contrary. Therefore, the moving amount of the steer bearing portion 221 in the case of releasing of pressing by the steer lock arm 222 for improving the operability of changing the belt 201 is set to be less than that in the case of releasing of pressing by the releasing screw 304.

By transporting the product with the tension applied to the belt 201 being weakened by the releasing screw 304 and by removing the releasing screw 304 from the tapped hole 213a after loosening the releasing screws 304 when the product is installed, the tension applied to the belt 201 can be returned to the initial state during the operation of the product. The releasing screws 304 may be completely removed when the product is installed or the releasing screws 304 may be left in the product as along as the releasing screws 304 are disengaged from the the tapped holes 213a. When the releasing screws 304 are left in the product, it is preferrable that the measure for the releasing screws 304 not to fall from the predetermined position is taken for example on the fixing cover 250.

With the above configuration, when the belt 201 is changed, the steer roller 205 is moved in the separating direction using the steer lock arm 222 and when the product is transported, the steer roller 205 is moved in the separating direction using the releasing screw 304. This enables the positional shift of the belt 201 due to the vibration during the transportation to be suppressed and the fixing device 200 whose belt 201 can be easily changed to be provided.

### Other Embodiments

In the previous embodiments, the fixing device is exemplified as the one in which un fixed toner image formed on a recoding material is fixed to the recoding material. However, this disclosure is not limited to such a fixing device. The present disclosure can be applied to for example an image heating device for a glossing device that increases the glossiness of an image formed on the recording material. The fixing device is exemplified by the one to be mounted on an image forming apparatus such as a printer and a copying machine. However, this disclosure is not limited to such a fixing device. The present disclosure can be applied to an image heating device which is not directly mounted on an image forming apparatus such as an image heating device to be mounted on a device arbitrarily attached to the image forming apparatus as an option.

In the previous embodiments, the fixing device is exemplified by the one in which un fixed toner image formed on a recoding material is fixed to the recoding material using an endless belt to which the tension is applied by a tensioning member. However, this disclosure is not limited to such a fixing device. The present disclosure can be applied to for example a belt conveying apparatus that bears and conveys a recording material using an endless belt to which the tension is applied by a tensioning member. The present disclosure can also be applied to for example a belt conveying apparatus that bears and conveys an image using an endless belt to which the tension is applied by a tensioning member. By applying the present disclosure to these belt conveying apparatuses, namely, by the configuration that these belt conveying apparatuses have the endless belt, the tensioning member, the first holding member and the second holding member which are described above, the same effect can be expected.

In the previous embodiments, the tensioning member is the steer roller that adjusts the position in the width direction perpendicular to the rotation direction of the belt 201 and also is a tension roller that endows tension to the belt 201. However, this disclosure is not limited to this. The tensioning member may be only a tension roller that endows the belt 201 with tension.

In the previous embodiments, although the image forming portion using four stations as image forming portions, the number of the stations is not limited to four. The number of stations may be appropriately set as required.

In the previous embodiments, a laser scanner is exemplified as an exposure unit. However, this disclosure is not limited to this. For example, an LED array can also be used.

In the previous embodiments, an image forming apparatus is exemplified as a printer. However, this disclosure is not limited to this. A copying machine, a facsimile apparatus, or a multi-functional printer having these functions can be an image forming apparatus. Further, the present disclosure can be applied to an image forming apparatus that uses a recording material bearing member, and transfers toner images of respective colors on a recording material borne by the recording material bearing member in a sequentially superimposed manner and the same effects can be obtained by applying the present disclosure to these image forming apparatuses or fixing devices used in these image forming apparatuses.

According to this disclosure, the positional shift of the endless belt due to vibration during transportation can be suppressed and the operability of changing the endless belt can be improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-217461,filed Dec. 12, 2024, which is hereby incorporated by reference herein in its entirety.

What is claimed is:

1. A fixing device comprising:
an endless belt rotatably suspended by a plurality of suspending members;
a pressurizing member that abuts against an outer circumferential surface of the endless belt;
a nip forming member that is brought in contact with an inner circumferential surface of the endless belt and that forms a nip portion between the endless belt and the pressuring member in a position opposed to the pressurizing member;
a tensioning member that rotatably suspends the endless belt and that presses the endless belt to endow the endless belt with tension;
a first holding member supported such that the first holding member can be moved between a pressing position where the endless belt is pressed by the tensioning member and a releasing position where the pressing by the tensioning member on the endless belt is released, the first holding member being configured to hold the tensioning member in the releasing position that is distanced from the pressing position in a direction opposite the pressing direction for a first distance; and
a second holding member configured to hold the tensioning member in the middle position distanced from the pressing position in a direction opposite the pressing direction for a second distance shorter than the first distance.

2. The fixing device according to claim 1,
wherein the tensioning member is a steering roller that has a rotation fulcrum at one end portion or at a center portion in a width direction perpendicular to a rotation direction of the endless belt, the steering roller being configured to control a position in the width direction of the endless belt by being rotated around the rotation fulcrum with respect to the endless belt to produce a difference in tension between one side and the other side of the endless belt in the width direction.

3. The fixing device according to claim 1,
wherein the tensioning member is a tension roller that is urged by a spring and that endows the endless belt with a predetermined tension.

4. The fixing device according to claim 1,
wherein the second holding member is provided each of both sides of the tensioning member in an outside region in the width direction perpendicular to a rotation direction of the endless belt, the second holding member being configured to abut against the tensioning member to restrict a movement of the tensioning member in the pressing direction.

5. The fixing device according to claim 4,
wherein the second holding member is a screw that is detachably attached to a supporting member that movably supports the tensioning member, the screw being configured to restrict a movement of the tensioning member by abutting against the tensioning member and by moving the tensioning member to the middle position by being tightened to the supporting member.

6. The fixing device according to claim 4,
wherein the second holding member is a restricting member that is detachably attached to a housing frame of the fixing device, the restricting member being configured to restrict a movement of the tensioning member by abutting against the tensioning member in the middle position.

7. The fixing device according to claim 1,
wherein a first pressing force with which the tensioning member presses the endless belt when the tensioning member is held in the releasing position by the first holding member is less than a second pressing force with which the tensioning member presses the endless belt when the tensioning member is held in the middle position by the second holding member.

8. The fixing device according to claim 1, further comprising:
a heating rotating member that rotatably suspends the endless belt and that is in contact with an inner circumferential surface of the endless belt to heat the endless belt,
wherein an area in which the heating rotating member is in contact with the endless belt is larger than an area in which the tensioning member is in contact with the endless belt.

9. The fixing device according to claim 8, further comprising:
a supplying member that rotatably suspends the endless belt and that abuts against the inner circumferential surface of the endless belt to supply lubricant.

10. An image forming apparatus comprising:
an image forming portion configured to form an image on a sheet; and
the fixing device according to any one of claims 1 to 9 that fixes the image formed on the sheet.
